(19) United States
(12) Patent Application Publication
(10) Pub. No.: US 2022/0283047 A1
(43) Pub. Date: Sep. 8, 2022

(54) FORCE SENSOR

(71) Applicant: CANON KABUSHIKI KAISHA, Tokyo (JP)

(72) Inventors: Naoya Ogawa, Kanagawa (JP); Atsushi Takasaka, Tokyo (JP)

(21) Appl. No.: 17/703,794

(22) Filed: Mar. 24, 2022

Related U.S. Application Data
(63) Continuation of application No. PCT/JP2020/035479, filed on Sep. 18, 2020.

(30) Foreign Application Priority Data
Sep. 30, 2019 (JP) 2019-180977

(51) Int. Cl. G01L 5/1627; G01L 5/169

(52) U.S. Cl. CPC G01L 5/1627; G01L 5/169

(57) ABSTRACT

A force sensor includes a support member, a force receiving member to be displaced with respect to the support member by an action of an external force, and a strain generating member having a scale holding portion and an elastic connection portion connecting the support member and the force receiving member. The force sensor further includes scales each serving as a detection target object and disposed on the elastic connection portion and the scale holding portion, and displacement detection elements mounted on a sensor substrate of the support member to face the scales in a one-to-one correspondence to detect movements of the scales. The force receiving member includes metal, and the strain generating member includes resin.

### CROSS-REFERENCE TO RELATED APPLICATIONS

This application is a Continuation of International Patent Application No. PCT/JP2020/035479, filed Sep. 18, 2020, which claims the benefit of Japanese Patent Application No. 2019-180977, filed Sep. 30, 2019, both of which are hereby incorporated by reference herein in their entirety.

### BACKGROUND OF THE INVENTION

### Field of the Invention

The present invention relates to a force sensor that detects a force acting from outside.

### Background Art

A force sensor is used as means for detecting an external force acting on the parts of an arm of an industrial robot or a manipulator for medical use or the like. As an example of the force sensor, a 6-axis force sensor using an optical displacement sensor is discussed in PTL 1. The force sensor discussed in PTL 1 includes a support member, a force receiving member, an elastic connection member connecting these members, and a displacement direction conversion mechanism disposed between the support member and the force receiving member. The displacement direction conversion mechanism is provided with a detection target object, and the movement of the detection target object is detected by a displacement detection element disposed on the support member to face the detection target object. For example, when an external force acts on the force receiving member in a state where the support member is fixed, the elastic connection member is elastically deformed, and a displacement corresponding to the direction and the magnitude of the external force with respect to the support member is generated in the force receiving member. At this moment, a displacement portion of the displacement direction conversion mechanism also deforms along with the deformation of the force receiving member, and the displacement portion of the displacement direction conversion mechanism is displaced in a direction orthogonal to the displacement of the force receiving member.

### CITATION LIST

### Patent Literature

PTL 1: Japanese Patent Laid-Open No. 2019-78561

In the force sensor according to the above-described conventional technique, the support member, the force receiving member, and the elastic connection member include similar materials, so that deformations caused by a force applied to the force receiving member occur in the support member and the force receiving member, except for the elastic connection member, resulting in decrease in the rate of action on the displacement of a scale.

In a case where the entire sensor is configured using components having low rigidity to increase the deformation of the elastic connection member, the rigidity of the force receiving member is also low, and an undesirable large deformation occurs, so that detection errors increase, resulting in drop in the sensitivity.

The force receiving member is fastened to a tool such as an end effector, so that the force receiving member is to be a member having high rigidity.

If the elastic connection member is made to be greatly deformable for a higher resolution, the elastic connection member becomes minute, which makes manufacturing difficult.

### SUMMARY OF THE INVENTION

The present invention is directed to providing a high-resolution force sensor that is easy to manufacture.

According to an aspect of the present invention, a force sensor includes a support member, a force receiving member configured to be displaced with respect to the support member by an action of an external force, an elastic connection portion connecting the support member and the force receiving member, a plurality of detection target objects arranged on the elastic connection portion, and a plurality of displacement detection elements arranged on the support member to face the plurality of detection target objects in one-to-one correspondence, and configured to detect movements of the plurality of detection target objects. The force receiving member includes metal, and the elastic connection portion includes resin.

Further features of the present invention will become apparent from the following description of exemplary embodiments with reference to the attached drawings.

### BRIEF DESCRIPTION OF THE DRAWINGS

FIG. 1 is an external perspective view of a force sensor according to a first exemplary embodiment of the present invention.

FIG. 2 is a cross-sectional diagram illustrating a schematic structure of the force sensor in FIG. 1.

FIG. 3A is a plan view illustrating a configuration of a strain generating member and a scale according to the first exemplary embodiment of the present invention.

FIG. 3B is a plan view illustrating a configuration of a strain generating member and a scale according to the first exemplary embodiment of the present invention.

FIG. 4 is a plan view illustrating a structure of a top surface of a sensor substrate included in the force sensor in FIG. 1.

### DESCRIPTION OF THE EMBODIMENTS

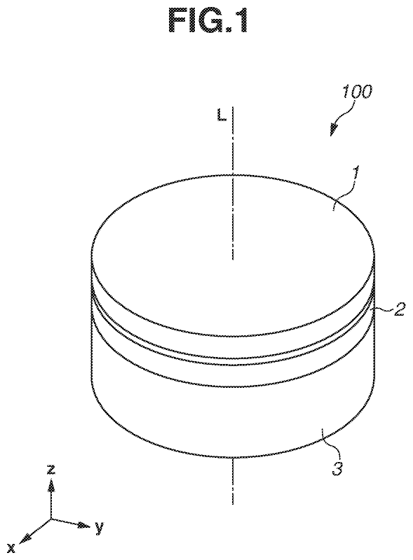

Exemplary embodiments of the present invention will be described in detail below with reference to the accompanying drawings. FIG. 1 is an external perspective view of a force sensor 100 according to a first exemplary embodiment of the present invention. The force sensor 100 includes a force receiving member 1, a strain generating member 2, and a support member 3. For convenience of description, an X-axis, a Y-axis, and a Z-axis are defined as illustrated in FIG. 1, and a direction indicated by an arrow in each of the axes is a + direction. The Z-axis is a direction parallel to the thickness direction of the force sensor 100, and an axis parallel to the Z-axis and passing through the center of the force sensor 100 (the center of the force receiving member 1 to be described below) is defined as a central axis L. The X-axis and the Y-axis are orthogonal to each other and also orthogonal to the Z-axis.

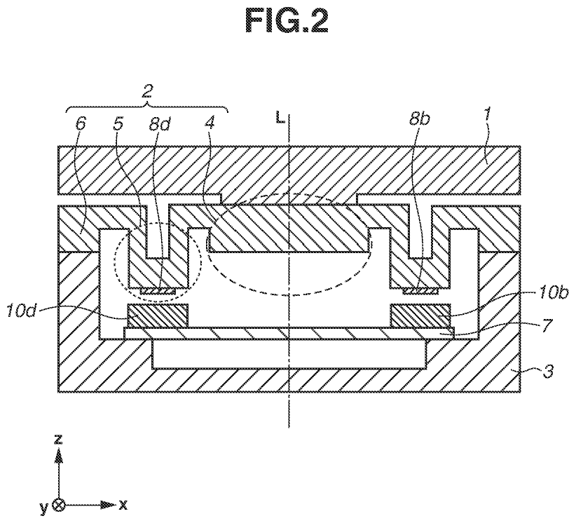

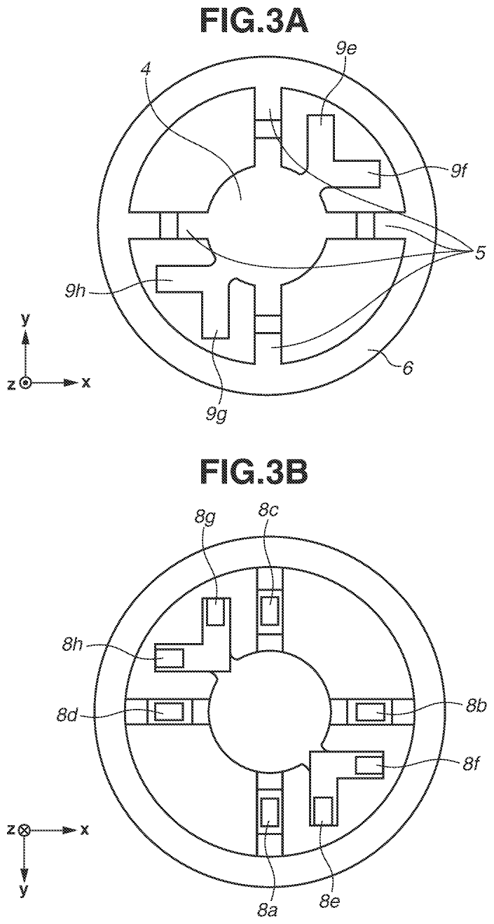

FIG. 2 is a cross-sectional diagram illustrating the force sensor 100 on a ZX plane including the central axis L, FIG. 3A is a diagram illustrating the strain generating member 2 when viewed from the Z direction, and FIG. 3B is a diagram illustrating the strain generating member 2 and scales 8a to 8h when viewed from the −Z direction. The force sensor 100 is a 6-axis force sensor, and can detect forces Fx, Fy, and Fz (in the X direction, the Y direction, and the Z direction, respectively) and moments Mx, My, and Mz (a moment around the X-axis, a moment around the Y-axis, and a moment around the Z-axis, respectively). Here, each of the X direction, the Y direction, and the Z direction is illustrated in each of the drawings.

The strain generating member 2 includes a central portion 4 (indicated by a broken oval in FIG. 2), elastic connection portions 5 (indicated by a dotted circle in FIG. 2) connected to the central portion 4, scale holding portions 9e to 9h connected to the central portion 4, and an external portion 6 connected to an end of the elastic connection portion 5 different from an end connected to the central portion 4.

A sensor substrate 7 is fixed to the strain generating member 2. The sensor substrate 7 may be directly fixed to the support member 3, but is less affected by the deformations of parts other than the strain generating member 2 in a case where the sensor substrate 7 is fixed to the strain generating member 2.

The support member 3 and the force receiving member 1 are connected by the strain generating member 2. Thus, the force receiving member 1 is displaceable with respect to the support member 3, and is inclinable about the X-axis, the Y-axis, and the Z-axis. The force sensor 100 is used with the support member 3 attached to a base or the like (not illustrated) and the force receiving member 1 attached to an arm of a robot or a manipulator (not illustrated). In the force sensor 100, the force receiving member 1 has a disk portion, and a columnar portion protruding from a central part of one plane of the disk portion, the other plane of the disk portion is attached to the arm of the robot or the manipulator, and the columnar portion is connected to the support member 3 via the strain generating member 2.

In the force sensor 100, the four elastic connection portions 5 are disposed between the external portion 6 and the central portion 4 to be substantially cross-shaped when viewed from the Z direction. In other words, the elastic connection portions 5 are disposed radially about the central axis L at four positions at 90-degree intervals in the XY plane.

The four elastic connection portions 5 each have a substantially U-shape to protrude in the −Z direction, and the scales 8a to 8d each serving as a detection target object are arranged at positions facing the sensor substrate 7, on the substantially U-shaped outer bottom surfaces of the four elastic connection portions 5. In other words, the elastic connection portion 5 has at least one protruding portion and the detection target object is arranged on the end surface of the protruding portion t. Further, the elastic connection portions 5 are radially arranged at equal intervals around the center of the force receiving member 1 and are substantially flush with each other.

The shape of the elastic connection portion 5 may have a substantially M-shape, a substantially L-shape, a substantially N-shape, or the like, instead of the substantially U-shape. These shapes make it possible to manufacture the strain generating member 2 through injection molding at low cost. From the viewpoint of dimensions, stress dispersion, and the magnitude of scale displacement with respect to an external force, the substantially U-shape is desirable.

Each of the elastic connection portions 5 described above is provided with one of the detection target objects.

The scale holding portions 9e to 9h are provided in a region corresponding to two quadrants symmetric about the central axis L among four quadrants divided by the four elastic connection portions 5 when viewed from the Z direction in the strain generating member 2. On the XY plane, the scale holding portions 9e and 9g are disposed at positions point-symmetric with respect to the central axis L, and the scale holding portions 9f and 9h are located at positions point-symmetric with respect to the central axis L.

The scales 8a to 8h each serving as the detection target object are each arranged on the corresponding one of the four elastic connection portions 5 and the scale holding portions 9e to 9h, to have substantially the same height in the Z direction (i.e., to be substantially flush with each other). Displacement detection elements 10a to 10h are mounted on the sensor substrate 7 to face the scales 8a to 8h, in one-to-one correspondence, in the Z direction. The scales 8a to 8h are arranged to have substantially the same height in the Z direction, and the components-mounted surface of the sensor substrate 7 is substantially parallel to the XY plane. Thus, the distance between the respective scales 8a to 8h and the corresponding one of the displacement detection elements 10a to 10h is substantially the same. Each of the displacement detection elements 10a to 10h is, for example, a light emitting element including a light emitting diode and a photodiode.

The elastic connection portions 5 each have a displacement direction conversion function. In other words, the substantially U-shaped bottom of the respective elastic connection portions 5 serves as a displacement portion to be displaced in the X direction or the Y direction (a second direction) with respect to the support member 3, by the displacement of the force receiving member 1 in the Z direction (a first direction). Specifically, when the external force Fz in the Z direction (the first direction) is input to the force receiving member 1, the scale 8a disposed on the elastic connection portion 5 is displaced in the −Y direction, the scale 8b is displaced in the −X direction, the scale 8c is displaced in the Y direction, and the scale 8d is displaced in the X direction. In a case where the moment Mx is input to the force receiving member 1, the scales 8a and 8c are displaced in the −Y direction. In a case where the moment My is input to the force receiving member 1, the scales 8b and 8d are displaced in the X direction. In a case where the external force Fx is input to the force receiving member 1, the scales 8e to 8h are displaced in the X direction. In a case where the external force Fy is input to the force receiving member 1, the scales 8e to 8h are displaced in the Y direction. In a case where the moment Mz is input to the force receiving member 1, the scales 8e and 8f are displaced in the Y direction and the −X direction, and the scales 8g and 8h are displaced in the −Y direction and the X direction.

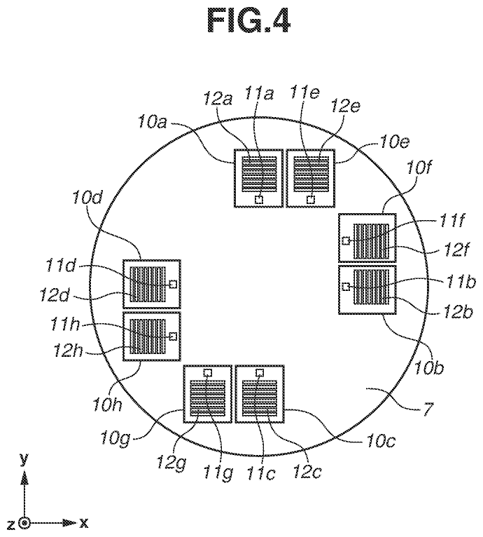

A description will be provided of a method of detecting the external forces and the moments acting on the force receiving member 1 by detecting the inclinations thus occurring in the scales 8a to 8h by using the displacement detection elements 10a to 10h. FIG. 4 is a plan view illustrating a configuration of the top surface of the sensor substrate 7. On the sensor substrate 7, the displacement detection elements 10a to 10h are disposed. The displacement detection elements 10a to 10h include light sources 11a to 11h, respectively, and light receiving elements 12a to 12h, respectively. The adjacent displacement detection elements among the displacement detection elements 10a to 10h coincide with each other in terms of the direction of a light receiving surface (direction indicated by stripes). In the present exemplary embodiment, while the example in which each of the light sources 11a to 11h and the corresponding one of the light receiving elements 12a to 12h are integrally formed and mounted is described, the light source and the light receiving element may be separately mounted.

Each of the light sources 11a to 11h is, for example, a light emitting diode (LED). In each of the light receiving elements 12a to 12h, a plurality of light receiving surfaces each serving as a detection surface is arranged in stripes. Although not illustrated, the scales 8a to 8h each include a substrate made of glass or the like, and a grating including a reflection film made of metal or the like formed on the front surface or the back surface of the substrate. The scales 8a to 8h are disposed to face the displacement detection elements 10a to 10h, respectively. When divergent light beams are emitted from the light sources 11a to 11h to the scales 8a to 8h, respectively, the reflected light from the scales 8a to 8h forms a pattern of diffracted light as bright and dark fringes on the light receiving elements 12a to 12h. The arrangement pitch of the light receiving surfaces of the light receiving elements 12a to 12h is made to coincide with a quarter cycle of the pattern of the diffracted light. Thus, when the scales 8a to 8h are displaced in the arrangement direction of the light receiving surfaces of the light receiving elements 12a to 12h, the pattern of the diffracted light on the light receiving elements 12a to 12h moves accordingly. Thus, two-phase sine wave shape signals (sin and cos) having a phase difference of 90 degrees are obtained from the light receiving surfaces of the light receiving elements 12a to 12h. When the arc tangent calculation (tan −1) of the obtained signal is performed, the amounts of displacements of the scales 8a to 8h in the above-described direction can be detected. From the amounts of displacements thus detected, the forces Fx, Fy, and Fz, and the moments Mx, My, and Mz, which are the six components of the external force, can be obtained through calculation.

As described above, in the force sensor 100, the scales 8a to 8d are disposed on the elastic connection portion 5. Thus, there is no need to separately provide a displacement conversion mechanism. The scales 8a to 8h are disposed to face in the same direction (the −Z direction), and it is only required that the displacement detection elements 10a to 10h are mounted on the sensor substrate 7 to correspond thereto, which facilitates assembling.

In the present exemplary embodiment, the force receiving member 1 includes metal (e.g., aluminum), and the strain generating member 2 includes resin (e.g., polyphenylene sulfide (PPS)). There are some ways to enhance the resolution of the force sensor. For example, an element having a high displacement detection resolution can be used, but such an element is often expensive. In order to enhance the resolution of the force sensor without increasing the resolution of the displacement detection element, the displacements of the scales 8a to 8h are to be increased with respect to the displacement detection elements 10a to 10h.

Among deformations caused by the external forces or moments input to the force receiving member 1, deformation contributing to the scale displacement is to be increased. If there is a deformation of a part not contributing to the scale displacement, the scale displacement becomes small. In a case where the force receiving member 1, the strain generating member 2, and the support member 3 are all made of the same material, not only the strain generating member 2 but also the force receiving member 1 and the support member 3 deform to some extent.

As a way of increasing the scale displacement, designing the substantially U-shape to be increased in height (the dimension in the Z-direction) is conceivable, but this also increases the overall height of the sensor.

As another way of increasing the scale displacement, decreasing the rigidity of the elastic connection portions 5 by slimming or thinning the elastic connection portions 5 is conceivable. In such a case, however, difficulty in manufacturing by machining or injection molding increases.

The above-described issues are solved by using metal as the material of the force receiving member 1, and using resin, which is less rigid than metal, as the material of the strain generating member 2, so that the deformation of the force receiving member 1 is decreased, and the deformation of the elastic connection portion 5 is increased. Thus, a force sensor in which the displacement of a scale is large, in other words, a robust and high-resolution force sensor can be realized.

Metal or resin can be selected as the material of the support member 3. In a case where metal is selected, the rigidity of the support member 3 increases, and thus this selection is more desirable.

The type of the resin of the strain generating member 2 can be selected depending on desired performance. In order to increase the dynamic range (maximum allowable measured load/resolution) of measurement, it is desirable to select a material having a large ratio between proof stress and Young's modulus. For example, materials such as PPS, polyetheretherketone (PEEK), polycarbonate (PC), and rubber are suitable. In a case where the elastic connection portions 5 each have at least one protruding portion, and the detection target object is arranged on the end surface of the protruding portion, this configuration is suitable for manufacturing by molding. Low-cost manufacturing can be achieved by selecting a moldable resin material.

Influence on a measurement error by thermal expansion can be reduced, by selecting, as the material of the strain generating member 2, a material having a thermal expansion rate close to those of the materials of the force receiving member 1 and the support member 3 and that of the material of the sensor substrate 7. For example, PPS containing glass fiber, which has a thermal expansion rate close to those of aluminum and glass epoxy, can be used.

In a case where the strain generating member 2 is produced from a plate material or the like by cutting or the like, the anisotropy of a deformation may increase if a fiber-reinforced resin is used, and thus this approach needs to be carefully considered. The anisotropy can be decreased by using an unreinforced resin material. In a case where the strain generating member 2 is produced through injection molding, the anisotropy of a deformation can be made small even if the fiber-reinforced resin is used.

In the present exemplary embodiment, the technique of optically detecting the displacement is used, but the technique of detecting the displacement is not limited thereto. For example, a detector of capacitance type or magnetostriction type may be used. In the case of the capacitance type, an amount of displacement of the detection target object can be detected by detecting a change in capacitance between the detection target object and the detection element that accompanies the displacement of the detection target object with respect to the detection element. In the case of the magnetostriction type, an amount of displacement of the detection target object can be detected by detecting a change in magnetic field caused by the displacement of the detection target object by using the detection element.

In the present exemplary embodiment, the strain generating member 2 and the force receiving member 1 are fastened by a bolt (not illustrated), but coupling by insert molding, coupling by fitting, or other coupling method may be used. Similarly, in the coupling between the strain generating member 2 and the support member 3, coupling by insert molding, coupling by fitting, or other coupling method may be used, in addition to bolt fastening. In a case where the bolt fastening is used, it is desirable to provide a tapped hole in each of the force receiving member 1 and the support member 3, without providing a tapped hole in the strain generating member 2. The durability of a thread can be improved by providing a tapped hole only in a high-strength material.

### Other Exemplary Embodiments

Although the present invention has been described above based on the preferred exemplary embodiments thereof, the present invention is not limited to these specific exemplary embodiments. Various embodiments within the scope not departing from the gist of the present invention are also included in the present invention. Furthermore, each of the above-described exemplary embodiments is merely an exemplary embodiment of the present invention, and the exemplary embodiments can be appropriately combined. For example, in the exemplary embodiments described above, the overall shape of the force sensor is cylindrical (shaped like a disk). In other words, the force receiving member has a disk portion, and a columnar portion protruding from a central part of one plane of the disk portion, and the support member has a cylindrical portion.

The columnar portion is connected to the cylindrical portion via the elastic connection portions.

However, the present invention is not limited to such a configuration. For example, instead of the strain generating member 2, a polygonal cylindrical member (a hexagonal cylindrical member, an octagonal cylindrical member, or the like) may be used, and a polygonal member may be used for the force receiving member 1 as well.

In addition, the number of the displacement detection elements, the scales, and the elastic connection portions may be reduced to provide a force sensor having less than six axes (e.g., three axes).

In any of these cases, it is desirable to provide a structure having point-symmetry with respect to the central axis L.

The present invention is not limited to the above-described exemplary embodiments, and various modifications and changes can be made without departing from the spirit and scope of the present invention. Accordingly, the following claims are attached to publicize the scope of the present invention.

According to the present invention, a high-resolution force sensor that is easy to manufacture can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A force sensor comprising:
a support member;
a force receiving member configured to be displaced with respect to the support member by an action of an external force;
a strain generating member including an elastic connection portion connecting the support member and the force receiving member;
a plurality of detection target objects arranged on the elastic connection portion; and
a plurality of displacement detection elements arranged on the support member to face the plurality of detection target objects in one-to-one correspondence, and configured to detect movements of the plurality of detection target objects,
wherein the force receiving member includes metal, and the elastic connection portion includes resin.

2. The force sensor according to claim 1,
wherein the elastic connection portion has a displacement portion to be displaced in a direction orthogonal to a first direction by displacement of the force receiving member with respect to the support member in the first direction, and
wherein the plurality of detection target objects is disposed on the displacement portion.

3. The force sensor according to claim 2,
wherein the elastic connection portion has at least one protruding portion, and
wherein the plurality of detection target objects is disposed on an end surface of the protruding portion.

4. The force sensor according to claim 1, wherein the plurality of displacement detection elements is substantially flush with each other.

5. The force sensor according to claim 1,
wherein a plurality of the elastic connection portions is radially arranged at equal intervals around a center of the force receiving member and is substantially flush with each other, and
wherein each of the plurality of elastic connection portions is provided with a different one of the plurality of detection target objects.

6. The force sensor according to claim 1, wherein the strain generating member is fastened to the force receiving member by a bolt.

7. The force sensor according to claim 1, wherein the strain generating member is coupled to the force receiving member through insert molding.

8. The force sensor according to claim 1, wherein the plurality of displacement detection elements optically detects displacement of the plurality of detection target objects.

9. The force sensor according to claim 1, wherein the plurality of displacement detection elements detects displacement of the plurality of detection target objects by detecting a change in capacitance between the plurality of detection target objects and the plurality of displacement detection elements.

10. The force sensor according to claim 1, wherein the plurality of displacement detection elements detects displacement of the plurality of detection target objects by detecting a change in magnetic field.

11. The force sensor according to claim 1,
wherein the force receiving member has a disk portion, and a columnar portion protruding from a central part of one plane of the disk portion,
wherein the support member has a cylindrical portion, and
wherein the columnar portion is connected to the cylindrical portion via the elastic connection portion.

12. The force sensor according to claim 1, wherein the force sensor has a structure symmetric about a central axis of the force receiving member, the central axis being parallel to a direction in which the plurality of detection target objects and the plurality of displacement detection elements face each other.

13. The force sensor according to claim 1, wherein the resin is polyphenylene sulfide (PPS), polyetheretherketone (PEEK), polycarbonate (PC), or rubber.

14. The force sensor according to claim 1, wherein the metal is aluminum.
